(19) United States
(12) Patent Application Publication
(10) Pub. No.: US 2014/0135972 A1
(43) Pub. Date: May 15, 2014

(54) Control Module for Deposition of Optical Thin Films

(71) Applicant: Ranko Galeb, Burlington, MA (US)

(72) Inventor: Ranko Galeb, Burlington, MA (US)

(21) Appl. No.: 13/954,859

(22) Filed: Jul. 30, 2013

Related U.S. Application Data
(60) Provisional application No. 61/725,289, filed on Nov. 12, 2012.

(51) Int. Cl. B05C 11/10; G05B 19/418

(52) U.S. Cl. CPC B05C 11/1013; G05B 19/4185
USPC 700/157

(57) ABSTRACT

The deposition controller controls a coating machine used in the deposition of the thin film coatings. The deposition controller is particularly useful for the deposition of multiple layers or co-deposition of multiple materials. The integrated system is a single hardware unit controlled by the software residing on the local computer. The single unit combines the functionality of a deposition controller, mass flow controller, quartz crystal controller, optical monitor chip change controller, and an optical monitor signal analyzer. The integrated system utilizes a Programmable Logic Controller (PLC) for the purpose of controlling the deposition process. A run sheet file is used by the system to create a set of process parameters. The system also examines a run sheet file at the time of its opening for its integrity with respect to the minimum layer optical thickness requirement expressed in terms of QWOT (quarter wave optical thickness). The controller utilizes an optimized polynomial regression function technique for the accurate layer termination while monitoring the reflection or transmission function and calculating its first and second derivatives to eliminate false termination points.

### CROSS-REFERENCE TO RELATED APPLICATIONS

This application claims the benefit of U.S. Provisional Application No. 61/725,289, filed Nov. 12, 2012.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to devices for controlling and monitoring vacuum deposition of thin films, especially thin films for optical applications.

2. Description of the Related Art

U.S. Pat. No. 4,311,725 issued in January, 1982, to Leslie Holland for a, “Control of Deposition of Thin Films”.

The multifaceted nature of optical thin films, expressed in terms of the refractive index, extinction coefficient, physical thickness, optical thickness, and the phase thickness can be fully recognized only by examining each constituent and its role throughout the coating cycle beginning in the design stage, going through the coating production, and ending in the quality control. Production of the optical coatings designed for applications in space programs, laser and medical instrumentation, and telecommunications requires equipment that employs most advanced control system for sequencing through the process steps that can include hundreds of layers.

Coating materials for optical applications can be deposited under vacuum conditions using different hardware. The coating materials evaporate when subjected to particular energy sources. Examples of such energy sources include electron beam sources, ion beam sources, and resistive sources.

In addition, there is an increasing demand for improving the densification of the deposited materials which can be accomplished with the ion sources.

Vacuum deposition is often performed in the presence of high purity gases. The flow of the high purity gas or gasses is regulated with the mass flow controllers. The mass flow controllers can also be used to maintain the chamber pressure at a constant level.

To create optical properties that are not possible using a single layer, multiple thin film layers of different materials can be deposited on a substrate. Creating a layer with a desired thickness requires precise timing when the deposition of the layer is to be terminated. To measure the thickness of a thin layer in situ, quartz crystal monitor or an optical monitor can be included in a chamber vessel and used continuously during the deposition.

Coating process can be generally divided into three steps: pre-deposition, deposition and post-deposition. Pre-deposition and post-deposition steps usually refer to the pump-down of the chamber vessel, heating and pre-cleaning of the substrates, and venting of the chamber. They are often carried out by dedicated controllers or the process control software.

The deposition step has been the most challenging part of the process control because the deposition step is based on the master-slave relationship between different electronic components. Traditionally, thin film deposition controllers have been designed to take a role of the master sequencer. The thin film deposition controller can execute a series of programming steps during initialization, execution, and termination of each successive layer. Layer termination is based on the frequency change of the oscillating quartz crystal sensor. Thin film deposition controllers can be configured to accomplish other tasks as well. If there is a need to optically monitor layer thickness, some commercially available optical monitors also offer layer sequencing. It is up to the coating machine manufacturer to decide how to integrate all these components into the operating system of the machine. To avoid limitations associated with using either a quartz crystal deposition controller or an optical monitor controller as master sequencers, coating machine manufacturers often configure the host application on the machine as a master sequencer by reading a recipe file that contains a sequence of layers and other relevant process parameters.

A typical vacuum deposition coating system for advanced optical thin films is equipped, among other hardware components, with the following:
1) a thin film deposition controller;
2) an optical monitor or optical monitor controller;
3) a mass flow controller;
4) a quartz crystal controller;
5) an optical monitor chip-change controller; and
6) communication links between the machine software and the hardware components mentioned above.

Prior-art devices, like the ones described in the previous paragraph, can be assembled from separately sold components. The components are not necessarily designed to integrate with each other. The components may be controlled by various, often different input signals, or by utilizing a communication link with other devices, such as serial communication. Similarly, the components may generate various output signals. The various input and output signals might be analog or digital.

With the exception of an optical monitor, which is an electro-opto-mechanical device of a rather complex design, the other electronic devices mentioned above share many features and functions that can be grouped together within a single controller that would be more reliable, less expensive, and easier to integrate into a new or existing equipment.

A quartz crystal sensor is used to indirectly measure thickness of a deposited thin film as a function of the crystal frequency. A quartz crystal is manufactured to oscillate at a particular starting frequency, for example 6 MHz. The sensor is placed near a deposition source, or a substrate to be coated. As material is vaporized and deposited onto the crystal, the frequency of the crystal decreases. The change in frequency of the crystal can be correlated to the deposition rate and the thickness of the deposited material. Quartz crystals must be periodically replaced as materials accumulate on them.

In the prior art, the quartz crystal sensors are connected to the proprietary PC boards to process the signals. The proprietary PC boards are typically integrated within the deposition controllers, and not within the other controllers or signal processors.

In the prior art, a dedicated crystal controller is used to move the crystals in the crystal holder, from one position to another. In some cases, the crystal controller can be replaced by assigning its functionality to the operating system of the coating machine, or by incorporating its functionality into the programmable logic of the deposition controller.

In contrast to quartz crystal sensors, the optical monitors directly measure optical thickness of the deposited layers. In the prior art, the optical monitor signals are not analyzed by the optical monitors or the control software utilizing an optimized polynomial regression function technique described below, but rather by a technique that is less accurate, and also prone to false interpretation of the signal change when the signal-to-noise ratio is low, or when the ambient noise interferes with a signal. To overcome those limitations, an operator is usually present at the machine, and manually terminates layer deposition based on the observed signal.

In the prior art, the mass flow controllers (MFC) are controlled by either a dedicated control hardware or the operating system of the coating machine. They are not integrated within a deposition controller and require a remote communication in order to regulate gas flow.

In the prior art, the optical monitor chip-change controller is usually integrated in the operating system of the coating machine. Sometimes its functionality can be incorporated into the programmable logic of the deposition controller.

Regardless of which method of layer sequencing is established, majority of the commercially available vacuum deposition systems suffer from the same drawback of an incomplete transfer of the relevant data for a particular coating design that has to be implemented in the production machine. This is primarily caused by the fact that the production machine software is typically configured to read the production version of the thin film design file in the form of the run sheet file. The run sheet file in general represents a set of data characteristic of a particular thin film design converted to a form suitable for the manufacturing process. On the other hand, the manufacturing process has its own multitude of different parameters that can be unique for each layer, and hence need to be configured for each layer. Some of these parameters can be grouped together to form a machine configuration file that characterizes different materials used in the thin film design file, such as the material tooling factors and the optical monitor setup data. The other parameters can be grouped together to form a file that describes the hardware of the deposition controller and the connected modules, such as the input/output assignment and the source/sensor/optical monitor configuration.

For complex processes, in particular those based on co-deposition of two or more coating materials, synchronizing communication between individual hardware components, while simultaneously performing demanding mathematical calculations related to the optical monitoring, becomes impossible for traditional controllers.

An example of the problem is the deposition of a layer, in a sequence of layers, that requires co-deposition of two or more materials, optical monitoring, change of the crystal sensor at the beginning of the layer, change of the optical monitoring chip at the beginning of the layer, prescribed flow of the process gas, prescribed background pressure in the coating chamber, prescribed electron beam sweep patterns applied to different deposition sources, and prescribed set of parameters to run the ion source. According to the prior art, a run sheet file is created from the thin film design software. The run sheet file does not consider the parameters of a particular deposition system mentioned above, but only the data derived directly from the thin film design software such as the layer name, layer thicknesses, optical monitor substrate type, optical monitoring signal values, number of turning points, and the monitoring wavelength.

In the prior art, to correct for the parameters of a particular deposition system, a recipe file derived from the run sheet file may be customized for a particular process by manually entering, on the production floor, empirical data based on the parameters of the particular deposition system. Manual entry of data leads to mistakes. Typically, the mistakes take the form of data that the deposition controller or the operating software of the coating machine cannot detect, or detects when the process has already started and advanced into the layer execution.

One of the most critical events in the deposition of the multilayer optical thin films is the termination of a layer growth at a precise moment when its optical thickness is equal to the one prescribed by the coating design. In that case, the optical monitoring is a preferred method of anticipating the exact time when to stop the deposition. The method includes illuminating the coated substrate with electromagnetic radiation of either a single wavelength or a broad spectrum. Changes in the optical signal of that radiation being transmitted or reflected by the substrate during the growth of the film are observed. Various methods of layer termination based on a single wavelength optical monitoring have been described in the prior art. They all rely on a raw signal being recorded and analyzed over certain period of time. However, without an extensive mathematical knowledge of the history of the signal, the accuracy of detecting a turning point or counting the number of turning points can be greatly compromised due to the presence of the ambient noise or low signal-to-noise ratio.

Therefore, in the light of the demand to manufacture optical thin films that may include multiple layers of co-deposited materials that require very precise monitoring of the layer thickness, a deposition controller is needed that can read a run sheet file that contains design data and machine hardware configuration data for each layer in the process sequence. By integrating the functionality of the individual components from the paragraph [0015] into a single control module, the reliability of the process control can be significantly improved, and the overall efficiency of the process control increased.

### SUMMARY OF THE INVENTION

To overcome the hardware redundancies and the software limitations mentioned above, an object of this invention is to provide a deposition controller for controlling and monitoring the deposition and co-deposition of the single and multilayer optical thin films.

A further object of the invention is to provide a deposition controller that utilizes parameters describing the configuration of the coating system and the multiple devices connected to the deposition controller, for the purpose of monitoring the deposition and co-deposition of the single and multilayer optical thin films.

A further object of the invention is to provide a deposition controller that is an integrated system. As an integrated system, the controller can provide a single hardware unit. This single unit can combine the functionality of a traditional deposition controller, mass flow controller, quartz crystal controller, optical monitor chip change controller, and an optical monitor signal analyzer. The controller can be modular to allow for the addition or removal of various components based on the system requirements. For example, additional relays, inputs, and outputs can be provided in a deposition controller that is configured to control and monitor deposition processes that require high level of customization. The single unit can be standardized case size such as a nineteen inch rack-mount enclosure.

Another object of the invention is to provide a deposition controller that is configured to be connected to a local computer and configured to read a process recipe file received from the local computer. The deposition controller can be configured to be connected to the local computer over a computer network such as a network that utilizes the TCP/IP protocol. The deposition controller can include an 8P8C modular connector (i.e. RJ45 connector) to connect the controller to the local computer.

Another object of this invention is to incorporate a Programmable Logic Controller (PLC) in the deposition controller. The PLC replaces a number of standalone electronic components and eliminates multiple communication links between the devices. The PLC increases the input/output capability of the system and provides more reliable and easier implementation of the communication between the host application and the deposition controller. The PLC hardware is off-the-shelf product readily available from several manufacturers of the electronic components. The PLC can be easily configured to connect to the TCP/IP networks. The PLC provides a digital computer with multiple input and output arrangements ideally suited for the integration of the individual components from the paragraph [0015] into a single control module, with the exception of the optical monitor component where only certain functions of the optical monitor can be integrated within the PLC. The PLC program that controls the logic and the functionality of the integrated components is typically written in a special application on a personal computer, and downloaded to the PLC using the Ethernet connection. The program is stored in the PLC in battery-backed-up RAM (random access memory).

A further object of this invention is to create a run sheet file derived from the thin film design file and the coating machine configuration file. In addition, the run sheet file contains a set of process parameters that describe the hardware configuration of the deposition controller and the connected modules. The input/output assignment and the source/sensor/optical monitor configuration form a database file that characterizes the hardware setup of each coating machine that is mapped into the deposition controller. This database file is the underlying element of the run sheet file, and enables a run sheet to be created and modified according to the deposition monitor configuration. For example, a run sheet includes parameters that describe when to perform certain control functions through the input/output assignment of the deposition controller. More specifically, the run sheet triggers execution of the events in the process sequence such as those related to the electron gun crucible control, the crystal sensor switch control, the optical monitor chip change control, the electron gun sweep pattern selection, the ion source power selection, and the MFC gas control.

A further object of the invention is to provide a deposition controller that is programmed to examine a run sheet file for its integrity with respect to the minimum layer optical thickness (MLOT) requirement expressed in terms of the quarter wave optical thickness (QWOT). When the deposition controller opens a given run sheet, a software application on the local computer can check the run sheet for compliance. The software application should check the run sheet file before the run sheet is executed in order to avoid starting a non-compliant run. By insuring the run sheet is compliant using the MLOT, a polynomial curve fitting algorithm can be utilized without error during the optical monitoring of the film thickness.

A further object of the invention is to provide a deposition controller that is programmed to fit a function to a set of discrete data points taken over time during the deposition process. The data points are the values of the signal generated by the optical monitor that represents intensity of the light reflected or transmitted by the growing thin film. The optical monitor can be set to the monitoring wavelength of interest. The number of data points should be as high as possible, but not so numerous to prevent efficient fitting of the function. An example of a method for fitting a curve to a set of data points is an optimized polynomial regression technique. The deposition controller can be programmed to calculate the first and second derivatives of the function. In turn, the deposition controller can accurately predict the occurrence of the turning point, and calculate the number of the turning points. Making decisions regarding the termination of the layer deposition which are based on the optimized polynomial regression technique greatly reduces false termination points due to the low signal-to-noise ratio, or the presence of the ambient noise in the optical monitor signal.

The invention further encompasses a method for creating a run sheet file for a deposition controller. The run sheet is intended to be executed by a deposition controller according to the invention. According to the invention, the run sheet incorporates a thin film design file including a datum that describes a thin film to be deposited, a coating machine configuration file that includes a datum describing a coating machine in which the thin film is to be deposited, and a deposition controller configuration file that includes a datum describing a deposition controller. With the data, the method calls for writing an instruction to the deposition controller where the instruction is derived from the datum describing the deposition controller, the datum describing the coating machine, and the datum describing the thin film to be deposited.

The invention further encompasses a method for examining a run sheet file. In the first step of the method, a minimum layer optical thickness (MLOT) is defined as the fractional value of the quarter wave optical thickness (QWOT) of the layer at the monitoring wavelength. The default value of the MLOT coefficient is 0.4, and can have values between 0.3 and 0.6. The next step involves suspending a deposition when a ratio of an optical thickness of the layer to the QWOT is less than the MLOT. The method also involves suspending a deposition when a ratio of an optical thickness of the layer before the first turning point to the QWOT is less than the MLOT.

In accordance with a further object of the invention, the quarter wave time segment (QWTS) represents a fractional value of the quarter wave time when the thin film acquires an optical thickness equal to QWTS times QWOT. In a preferred embodiment, the QWTS is not less than 0.45 times MLOT and the QWTS is not more than 0.65 times MLOT.

The invention further encompasses a method for terminating deposition of a thin film. The first step of the method involves calculating a number of polynomial data points by dividing a product of a QWTS and a physical thickness (PT) of a layer by a product of a deposition rate of the growing film (RATE), an optical thickness of the layer (OTQW), and an optical monitor sampling interval (OMSI). The next step calls for collecting the number of polynomial data points periodically by measuring an intensity of a light signal reflected from or transmitted through the growing thin film each time the OMSI passes. The next step calls for calculating a polynomial regression function from the number of the polynomial data points, and calculating the first and the second derivatives of the function. The last step calls for terminating the deposition of the thin film based on the value of the regression function.

In accordance with a further object of the invention, an optical sensor is maintained at a given wavelength while calculating a polynomial regression function.

Other features that are considered as characteristic for the invention are set forth in the appended claims.

Although the invention is illustrated and described herein as embodied in a deposition controller, the invention should not be limited to the details shown in those embodiments because various modifications and structural changes may be made without departing from the spirit of the invention while remaining within the scope and range of the equivalents of the claims.

The construction and the method of operation of the invention and additional objects and advantages of the invention is best understood from the following description of the specific embodiments when read in connection with the accompanying drawings.

### BRIEF DESCRIPTION OF THE SEVERAL VIEWS OF THE DRAWING

FIG. 1 is a schematic chart showing functional relationships between the different segments of the optical thin film software and the deposition controller according to the invention.

FIG. 2 is a diagrammatic, sectional top side view showing the deposition controller with its cover removed.

FIG. 3 is a diagrammatic, rear side view showing the deposition controller from FIG. 2.

FIG. 4 is a screenshot of a human machine interface generated by the deposition monitor where the inputs and outputs of the deposition controller shown in FIG. 2 are configured.

FIG. 5 is a screenshot of the human machine interface generated by the deposition monitor where the deposition sources of the deposition controller shown in FIG. 2 are configured.

FIG. 6 is a screenshot of the human machine interface generated by the deposition monitor showing a real time status of the inputs and outputs configured in FIG. 4.

FIG. 7A is a screenshot of the human machine interface generated by the deposition monitor showing a status of the deposition rate and the thickness of the layer obtained from the quartz crystal monitor used in the deposition controller shown in FIG. 2.

FIG. 7B is a screenshot of the human machine interface generated by the deposition monitor showing a status of the deposition rate obtained from three quartz crystal monitors assigned to the sources 1, 2, and 3, and used in the deposition controller shown in FIG. 2.

FIG. 8 is a screenshot of the human machine interface generated by the deposition monitor showing a graph that plots an optical monitor signal change versus a thickness of the thin film.

FIG. 9A is a screenshot of the human machine interface generated by the deposition monitor showing a graph of an optical monitor signal change versus time.

FIG. 9B is a screenshot of the human machine interface generated by the deposition monitor showing a graph of an optical monitor signal change versus time that plots a polynomial regression function and the raw polynomial data points during the layer growth.

### DETAILED DESCRIPTION OF THE INVENTION

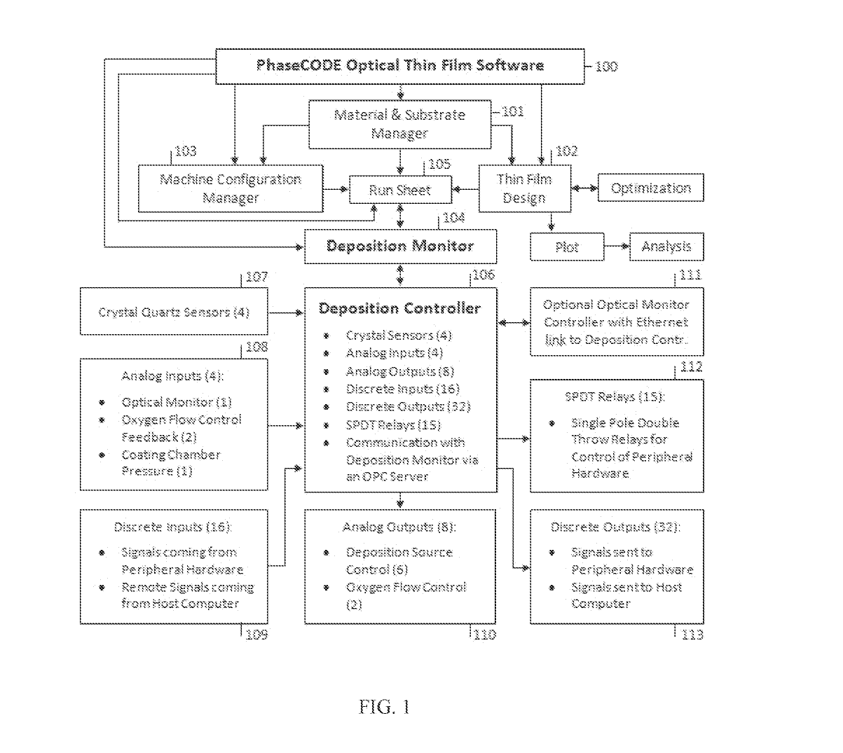

FIG. 1 is the flowchart representing a functional relationship between the different modules of the optical thin film software 100, such as the PhaseCODE available from Galeb Optics of Trinity, Fla., and a deposition controller 106. The software 100 runs on a local computer, which is not shown. The local computer includes a network interface controller (NIC). In a preferred embodiment, the NIC communicates using the TCP/IP protocol. At box 101, the coating materials and substrates are defined in terms of the refractive indices and the extinction coefficients for the range of wavelengths. Three preferred regression methods can be used for interpolation and extrapolation of material and substrate data: polynomial, rational function, and linear. Corresponding data is available to other program modules through the application database. At box 102, a coating design is created or modified using materials and substrates defined in box 101. At box 103, a coating machine configuration is created or modified using materials and substrates defined in box 101. The machine configuration contains names of the particular materials and substrates, type of thickness monitoring implemented during the deposition cycle, tooling factors specific for the machine, and the optical monitor setup data. At box 104, an additional set of data is created for each machine configuration defined in box 103. Box 104 represents the deposition monitor which is a Human Machine Interface (HMI) between the optical thin film software 100 and the deposition controller 106. The HMI preferably includes a video display connected to the computer. This additional set of data 104 is related to the hardware configuration of the coating machine and includes the following:
1) a deposition source configuration 110;
2) a quartz crystal sensor configuration 107;
3) an optical monitor chip changer configuration 112;
4) a timer configuration for sources, sensors and optical monitor chip changer 112 and 113;
5) input and output configuration for the control of the peripheral hardware components such as deposition sources, ion sources, crystal sensors, power supplies, vacuum controllers, alarms, as well as the process states 109, 112, and 113; and
6) an optical monitor, chamber pressure and gas configuration 108, 110, 112, and 113.

Analog outputs 110 and discrete outputs 113 are used for the material and the co-deposition configuration. The analog outputs 110 are preferably connected to the deposition source controls and the gas flow controls. The discrete (i.e. digital) outputs 113 are used to send the signals to the peripheral hardware components connected to the deposition controller 106, and to the digital inputs of the main operating system of the coating chamber.

At box 105, a run sheet file (also referred to as a “run sheet”) is created or modified. The run sheet 105 includes the design defined in box 102, the machine configuration defined in box 103, the materials and substrates defined in box 101, and the deposition monitor machine configuration defined in box 104. Because all contributing files to the run sheet 105 are part of the application database, the range checking is performed for each data entry, thus eliminating any possibility of configuring the process parameters that would not be in accordance with the machine hardware configuration. Also, any changes made to the contributing files after the run sheet 105 has been created will be automatically incorporated into the run sheet 105 when the file is opened next time.

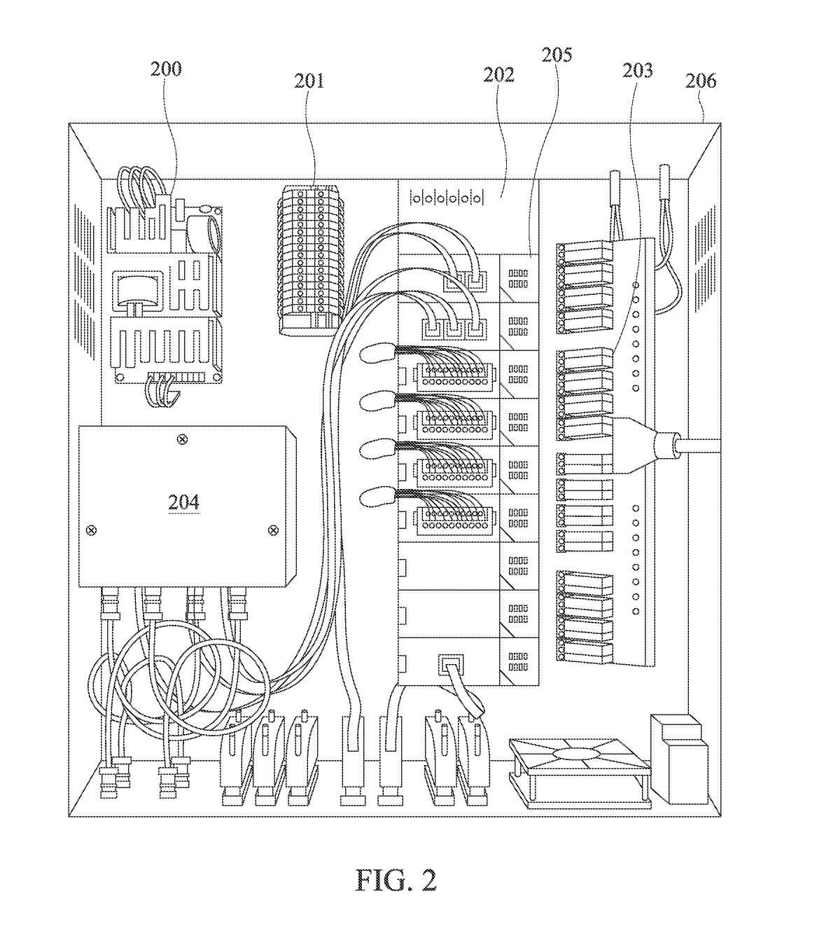

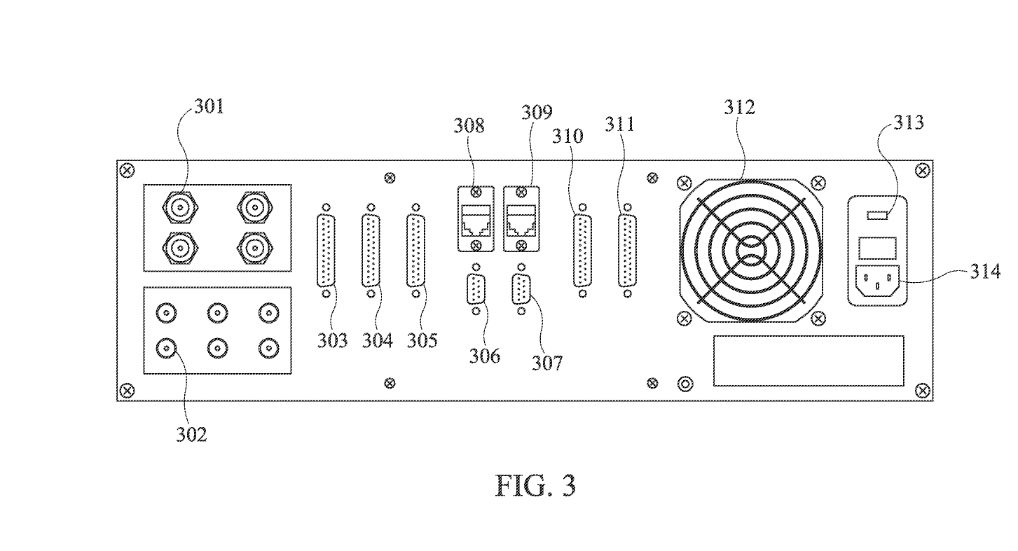

Box 106 represents a deposition controller hardware unit that is shown in detail in FIGS. 2-3 and that includes the following:
1) four (4) quartz crystal sensor boards such as those sold by Sycon Instruments of East Syracuse, N.Y. under the trade name STM-1 Single Board Thin Film Deposition Thickness/Rate Monitor;
2) sixteen (16) discrete inputs;
3) thirty-two (32) discrete outputs;
4) fifteen (15) relays;
5) four (4) analog inputs;
6) eight (8) analog outputs;
7) Ethernet port for communication with a local computer;
8) Ethernet port for communication with an optional optical monitor;
9) PLC (Programmable Logic Controller) with nine-slot base available as D2-09B-1 Direct Logic DL205 Base from Automationdirect.com of Atlanta, Ga.; and
10) miscellaneous hardware components as part of a nineteen (19) inch wide by five and one quarter (5.25) inch high by eighteen (18) inch deep rack-mount enclosure.

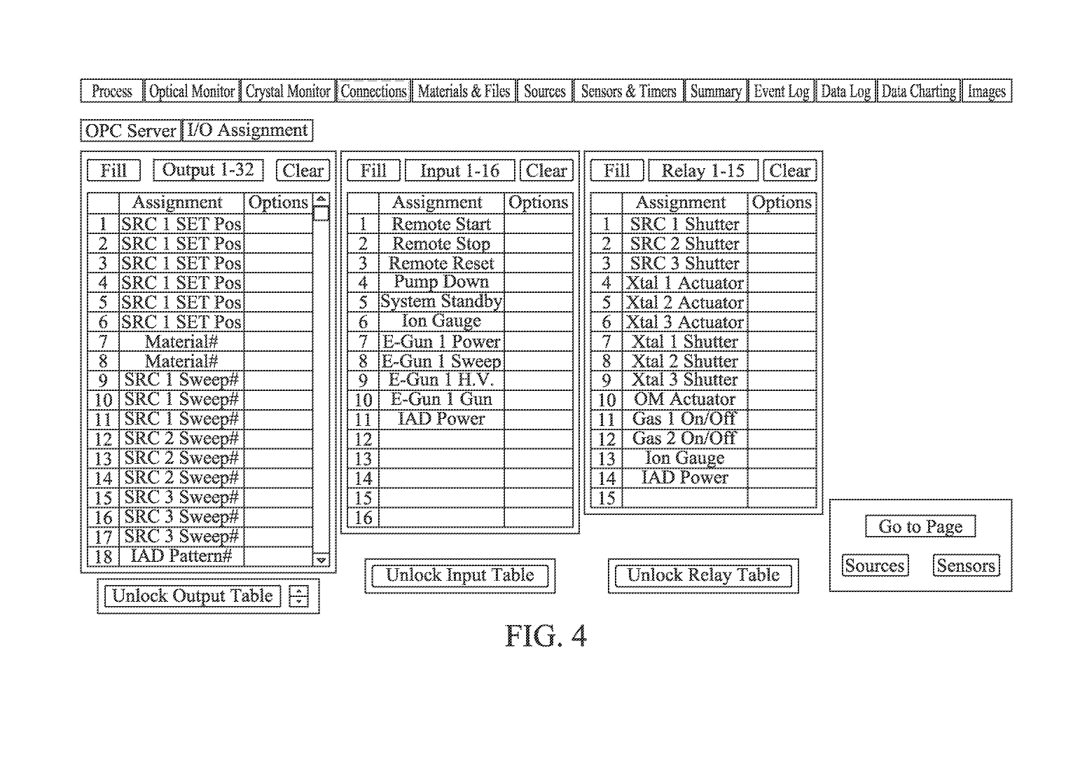

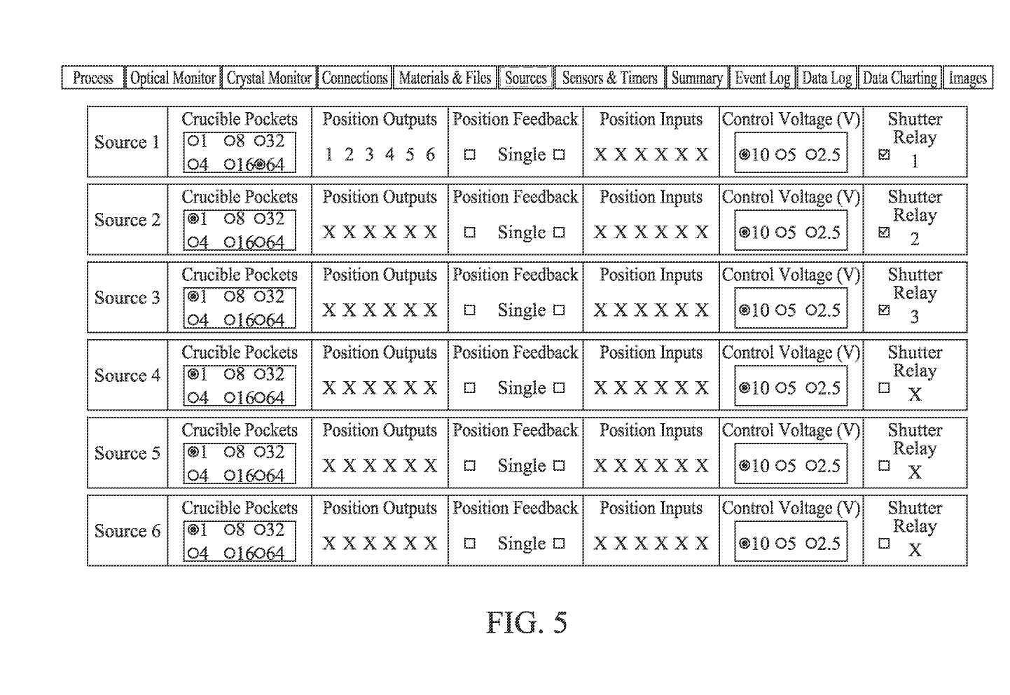

FIG. 2 is the top view of the deposition controller within a rack-mount enclosure 206. Dual voltage DC power supply 200 provides 5V DC for four quartz crystal sensor boards 204, and 24V DC for analog input and output modules installed in the nine-slot PLC base 202. The firmware of the PLC CPU module 205 operates in conjunction with the optical thin film software 100, shown in FIG. 1. The scan interval of the CPU module is 100 ms. The communication between the thin film software 100, also called a client, and the CPU module is based on an OPC (Open Platform Communication) server application residing on the local computer along with the client application. The update interval of the client is 200 ms, which is the time it takes to refresh the values of all variables monitored by the client and declared within the CPU module. Digital and analog input and output modules within the PLC base are configured through the HMI (Human Machine Interface) of the deposition monitor; see box 104 of FIG. 1, FIG. 4, and FIG. 5. The power distribution strip 201 is the power terminal for various components within the deposition controller 106. A bank 203 of fifteen (15) single point double throw relays is included for switching the external components.

A preferred embodiment of a deposition controller is a quartz crystal sensor board 204 such as the one sold by Sycon Instruments under the trade name STM-1. The deposition rate and thickness monitor uses 6 MHz crystals. Each quartz crystal sensor board 204 is connected to a respective PLC unit using a serial communication, such as RS-232. In a preferred embodiment, the PLC samples a frequency of connected quartz crystal sensors ten times per second (10×/s). The crystal frequency is converted to the rate and the thickness measurement by the PLC firmware.

As mentioned in the previous paragraph, a preferred embodiment of a deposition controller includes a plurality of crystal monitors. The standard configuration provides for four crystal sensors to be connected to the deposition controller. For advanced deposition techniques based on the co-deposition, a single controller can monitor and control the deposition of up to three materials simultaneously. For example, if a single layer is to be deposited from three sources, the deposition controller can be connected to three crystal sensors used to control the deposition rate of each source, and the fourth crystal sensor used for the thickness measurement of the growing film. The information from the crystal monitors is processed by the deposition controller. As discussed in more detail below, the deposition controller can adjust or stop the deposition of a particular layer. In a preferred embodiment that is shown, the deposition controller can be connected to four crystal sensors, which are not shown. The preferred embodiment might be used to control the deposition of up to 1000 layers where each layer is formed by the co-deposition of up to three materials.

FIG. 3 shows the rear view of the deposition controller with the digital, analog, and the crystal sensor connections described at box 106 of FIG. 1. BNC connectors 301 and 302 can be used to connect devices that transmit analog signals, typically on a coaxial connector. BNC connectors 301 and 302 are also known as Bayonet Neill-Concelman connectors. In a preferred embodiment, a maximum of four quartz crystal sensors can be connected to the BNC connectors 301, which are in turn connected to four quartz crystal sensor boards 204. In the co-deposition process, typically a first quartz crystal sensor can be positioned by a first source to monitor the deposition rate of that source, and connected to a first BNC connector 301. A second quartz sensor can be positioned in a deposition chamber close to the second source to monitor the deposition rate of that source, and connected to a second BNC connector 301. A third quartz sensor can be positioned in the deposition chamber near a substrate to measure a thickness of a deposited layer, and connected to a third BNC connector 301. The BNC connectors 302 are analog outputs that can be connected to high voltage power supplies that in turn control the power to the deposition sources (i.e. the respective emitters). In a preferred embodiment, a zero to ten volt (0-10 V) analog signal is applied at each BNC connector 302. Sixteen (16) discreet inputs are located at the connector 303. Sixteen (16) discreet outputs are located at the connector 304. Sixteen (16) discreet outputs are located at the connector 305. A network interface controller (NIC) 308 is used to connect the controller 106 to a local computer. In a preferred embodiment, the NIC 308 is an RJ45 socket used as an Ethernet connection between the controller 106 and a local computer. The NIC 308 preferably transmits signals that comply to the TCP/IP standard. NIC 309 can be used to connect to the peripheral devices, in particular the ones that send large amount of data with high sampling frequency. In a preferred embodiment, the NIC 309 can be connected to an optical monitor. Four (4) analog inputs 306 can be used to connect the controller 106 to the peripheral devices that send analog signals, such as mass flow controllers, ion gauge controllers, and optical monitor controllers. Two (2) analog outputs 307 can be used to connect the controller 106 to the peripheral devices that receive analog signals, such as mass flow controllers. Connector 310 connects to a bank 203 of fifteen (15) single pole double throw relays, and provides switching function for eight (8) external components that can be controlled by the controller 106. Connector 311 connects to a bank 203 of fifteen (15) single pole double throw relays, and provides switching function for seven (7) external components that can be controlled by the controller 106. A power source is included with a cooling fan 312, voltage selector 313, and an electrical socket 314.

FIG. 4 is the section of the HMI where the digital inputs and outputs are configured for a particular coating machine. Depending on the machine configuration, from a drop-down menu one can easily assign the IO functionality to various hardware components connected to the deposition controller. The deposition controller enables integration of the multiple hardware components, such as a rate controller, a gas controller, a quartz crystal position controller, and an optical monitor chip changer controller, into a single PLC driven control unit. The input output (IO) capability of the nine-slot PLC base provides multiple options for remote control of the peripheral hardware.

In a preferred embodiment, the digital inputs and outputs of the deposition controller from FIG. 4 that connect to the peripheral devices have the following qualities. A +24V DC signal is an input to each digital input. Likewise, a +24V DC signal is an output from each digital output. The relays are single-pole, double-throw, with a rating of 10A.

FIG. 5 is the section of the HMI where the deposition sources 101 are configured. A maximum of six (6) sources can be configured and controlled by the deposition controller. The default number of crucible pockets for each source is one, which means that no digital outputs are initially assigned that could be used to control the crucible position. For example, in FIG. 5, the selected number of crucible pockets for the source one is sixty-four (64). When the user selects the radio button 64, the program checks the deposition monitor input/output database file for availability of additional six digital outputs. The six outputs represent the binary values of all possible crucible positions in the range 1 through 64 that can be used to drive the crucible. If they are available and not already used or reserved for some other functions, the program automatically assigns their values based on the order of availability. In this particular case, those are the outputs 1 through 6. If the user selects the checkbox for the source one position feedback, the program checks the deposition monitor input/output database file for availability of additional six digital inputs. In this particular case, the position feedback checkbox is not selected, and no digital inputs are assigned for the source one actual crucible position. Similarly, the control voltage and the shutter relay can be assigned for each source. In the example of FIG. 5, all the sources have a control voltage set to 0-10 V DC. The shutter assignment for the sources 1 through 3 is set to relays 1 through 3, respectively.

In a similar way described in the previous paragraph, the quartz crystal sensors can be configured to be controlled through the input/output assignment of the deposition controller.

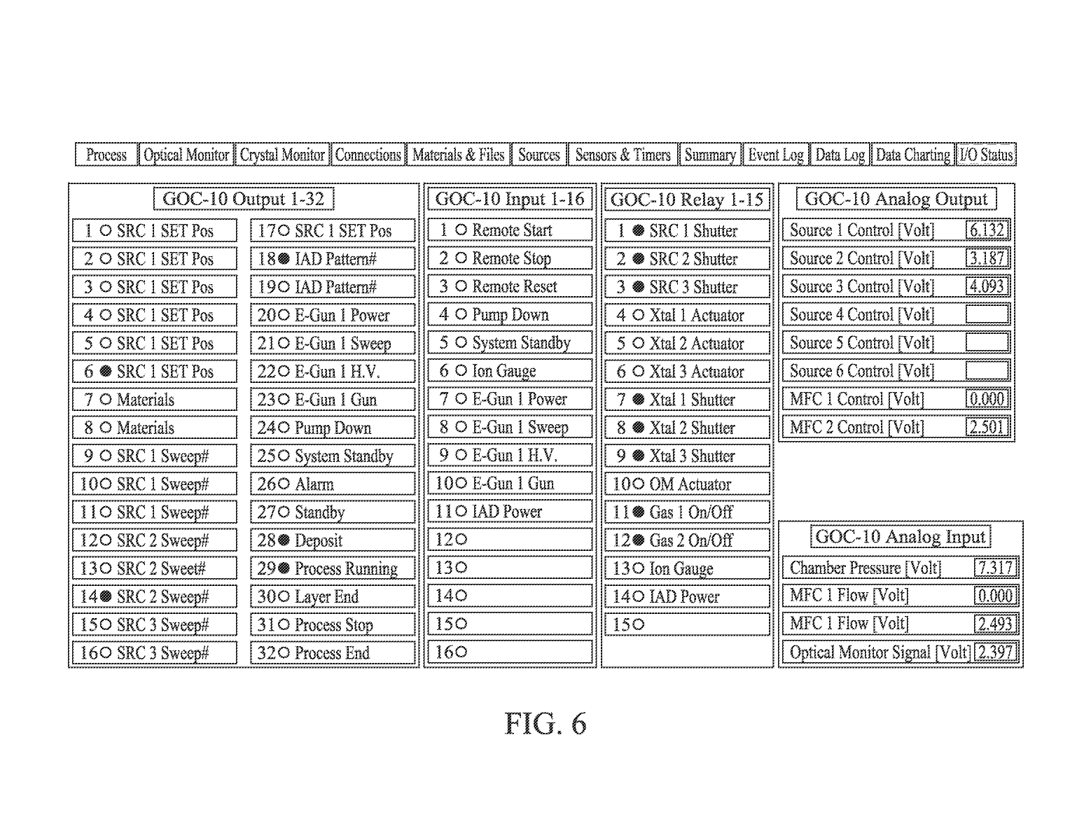

FIG. 6 is the real time status of the assigned discrete inputs 109, discrete outputs 113, analog inputs 108, analog outputs 110, and relays 112.

FIGS. 4 and 6 demonstrate the IO capability of the deposition controller. FIGS. 4 and 6 are actually examples of the IO assignments that are fully imbedded into the run sheet 105. For instance, in FIG. 4, the first six outputs are all assigned to the source 1 position. Because they represent the binary values, there are sixty-four (64) positions that the source 1 can acquire. As a consequence, during a run sheet creation or modification, the user cannot enter in the field for the source 1 position any other value but the one in the range 1 to 64. In the same way, the range checking is performed for any other assigned IO value that the user can access in the process of creating a run sheet.

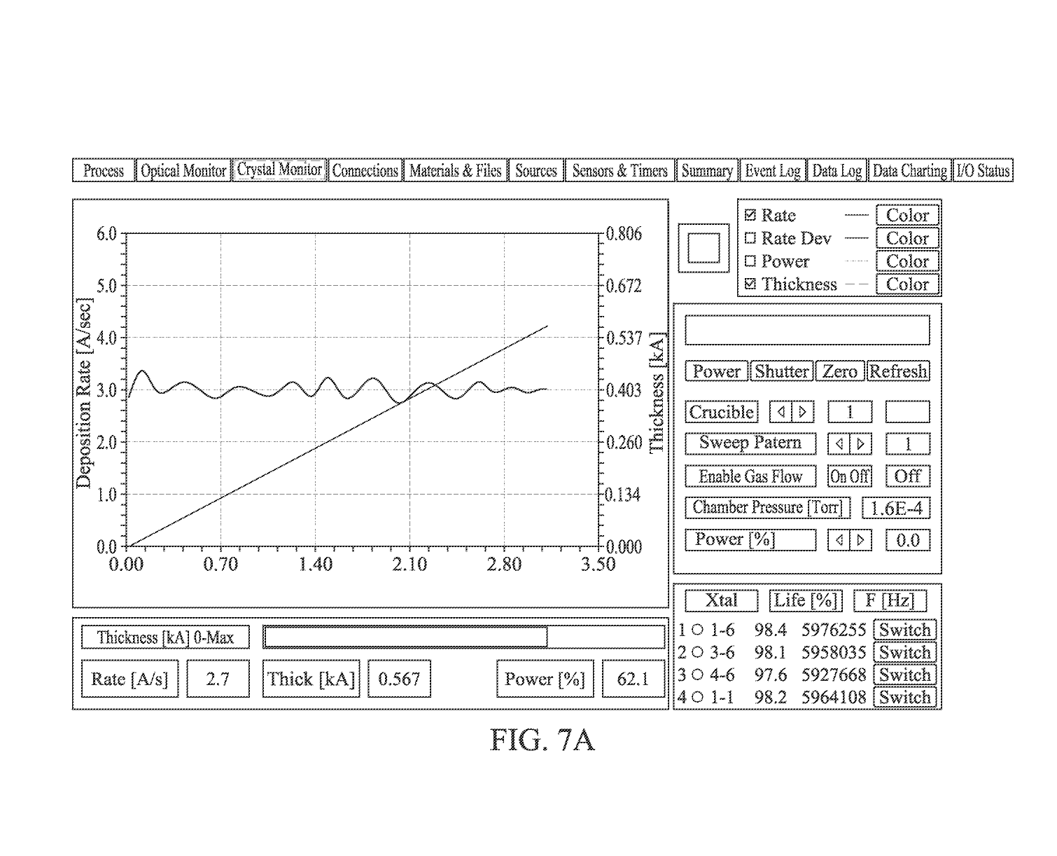

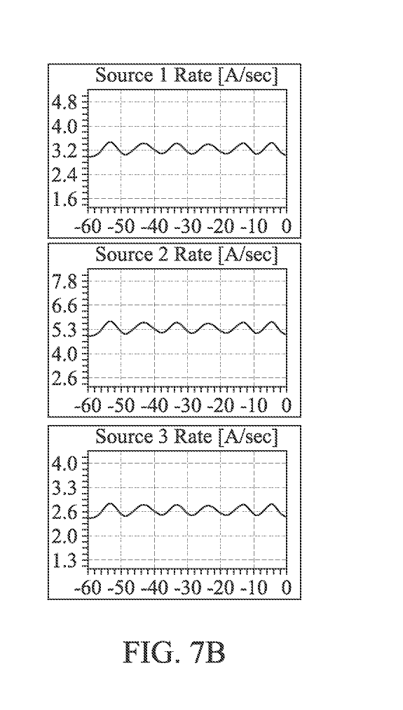

FIGS. 7A and 7B represent the status of four quartz crystal sensors, their position indicators, and the corresponding deposition rates.

A plurality of programmable logic controllers can be combined. In the embodiment shown, a nine slot base 202 was chosen based on the need for adding inputs and outputs versus the limitation of the size of the case. If more or less inputs and outputs were desired, the number of PLC controllers could be adjusted and a larger case could be used. Similarly, the size of the base 202 for connecting the PLC controllers can be adjusted.

A Programmable Logic Controller 202, PLC or Programmable Controller is a digital computer. A PLC is preferred to other general-purpose computers because PLC can be configured to work various, multiple input and output arrangements.

The method of optical monitoring during the deposition process is explained elsewhere, in particular in U.S. Pat. No. 4,311,725, which is incorporated by reference. Applicable to this invention, the optical monitor hardware components are installed on the vacuum coating chamber so that the light, from the light source, upon reflection or transmission from the substrate exposed to the stream of the deposited material, is directed towards the detector. The light source can be either monochromatic or polychromatic. With a polychromatic light source, a single wavelength is extracted from the light beam by placing a monochromator in front of the detector. The optical monitoring system is calibrated to produce an analog signal proportional to the intensity of the monochromatic light striking the detector. The analog signal is further connected to the input analog port 306 of the deposition controller; see FIG. 3.

A new process can be initiated by opening a run sheet file 105 with the optical thin film software 100. The run sheet 105 describes a sequence of layers where each layer can be terminated by either quartz crystal monitor or an optical monitor. When saving or opening a run sheet 105, all layers that are terminated by an optical monitor are examined with respect to the shape of their corresponding reflectance or transmittance curves. The minimum layer optical thickness, MLOT, is defined in terms of the fractional value of QWOT (quarter wave optical thickness) of the layer at the monitoring wavelength. The purpose of introducing MLOT is to secure a certain number of measurements taken over sufficiently long period of time before the first optimized curve fitting polynomial function is calculated. The default value of the MLOT coefficient is 0.4, and the coefficient can have values between 0.3 and 0.6. The optical thickness of the layer must be at least equal to MLOT×QWOT before the curve fitting algorithm is applied and the first optimized function evaluated. When the layer deposition is terminated using optical monitoring, if the ratio between the optical thickness of the whole layer or the optical thickness of the layer before the first turning point and the QWOT of the layer is less than MLOT, the opening of the run sheet file will be suspended. In that case the polynomial curve fitting algorithm cannot be properly applied when terminating layer deposition. This feature is an important safeguard against accidental changes that can affect the run sheet file. Before any changes are made to any of the constituent files, the user is prompted about the consequences those changes could have on the run sheet.

The quarter wave time segment, QWTS, is a coefficient defined by

0.45×MLOT≦QWTS≦0.65×MLOT

QWTS represents a fractional value of the quarter wave time in which the growing film acquires an optical thickness equal to QWTS×QWOT.

The number of polynomial data points, PDP, used by the regression algorithm, is given by

PDP=QWTS×PT/(RATE×OTQW×OMSI)

where the optical monitor sampling interval, OMSI, is defined as the time difference between the two adjacent discrete values of the analog signal that form a series of evenly spaced data points. PT represents the physical thickness of the layer, OTQW is the optical thickness of the layer expressed in terms of QWOT, and the deposition rate of the growing film, RATE, is defined as the PT change per second.

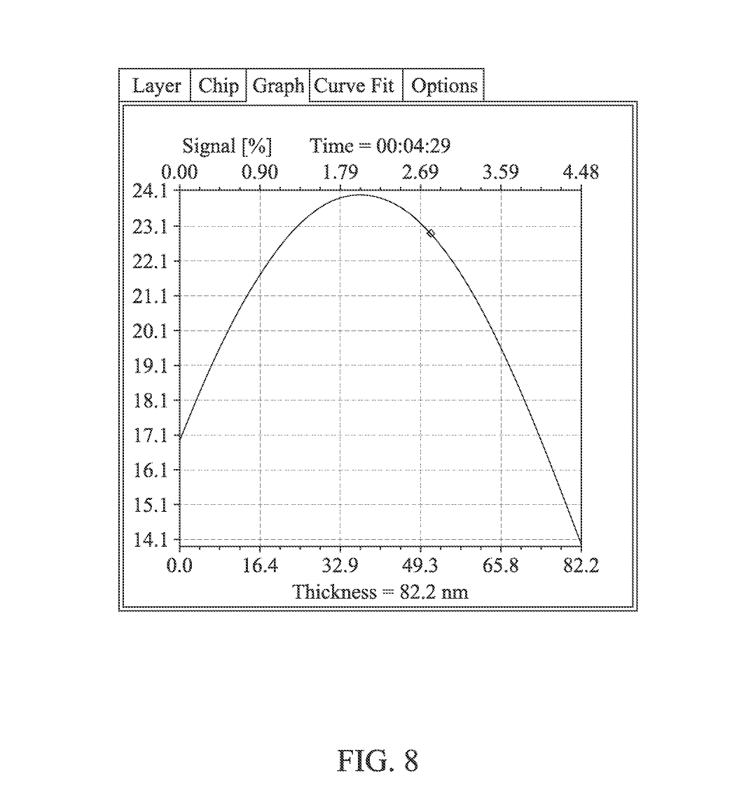

FIG. 8 is an example of the optical monitor signal change obtained from the run sheet 105. The signal represents the reflection from the optical monitoring chip during the co-deposition of three materials simultaneously evaporated from the three deposition sources. The deposition rate from each source is monitored by a dedicated crystal sensor shown in FIG. 7B. The deposition rate of the compound material produced by the combination of the three materials is shown in FIG. 7A.

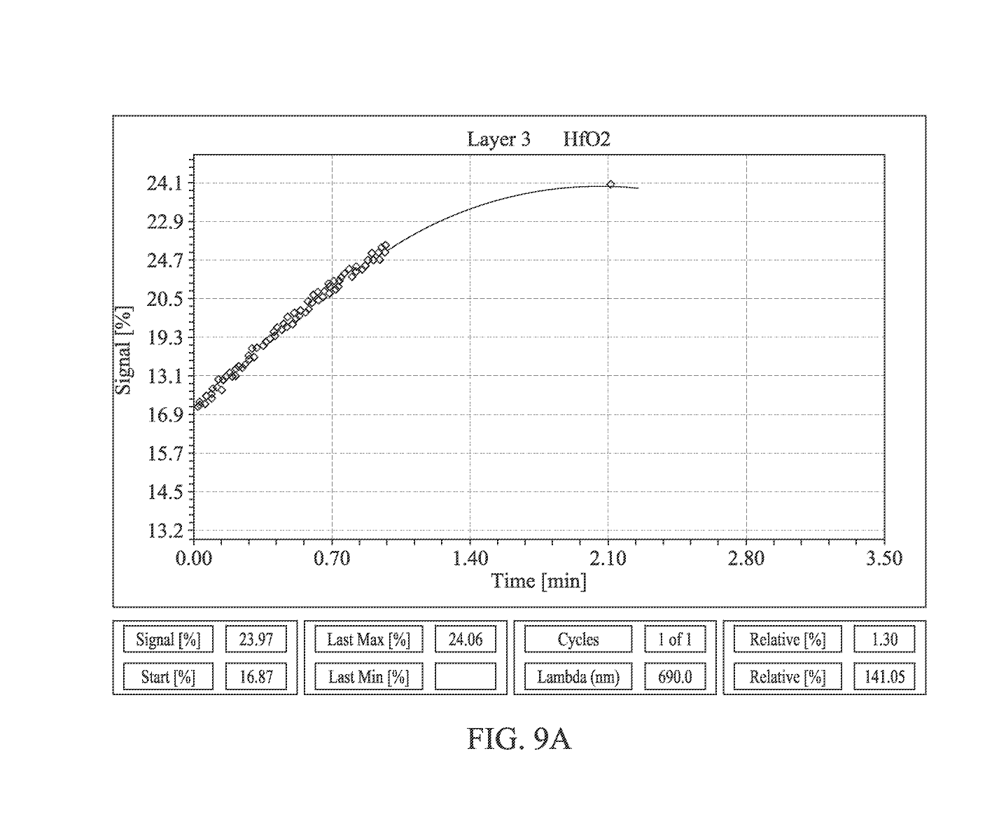

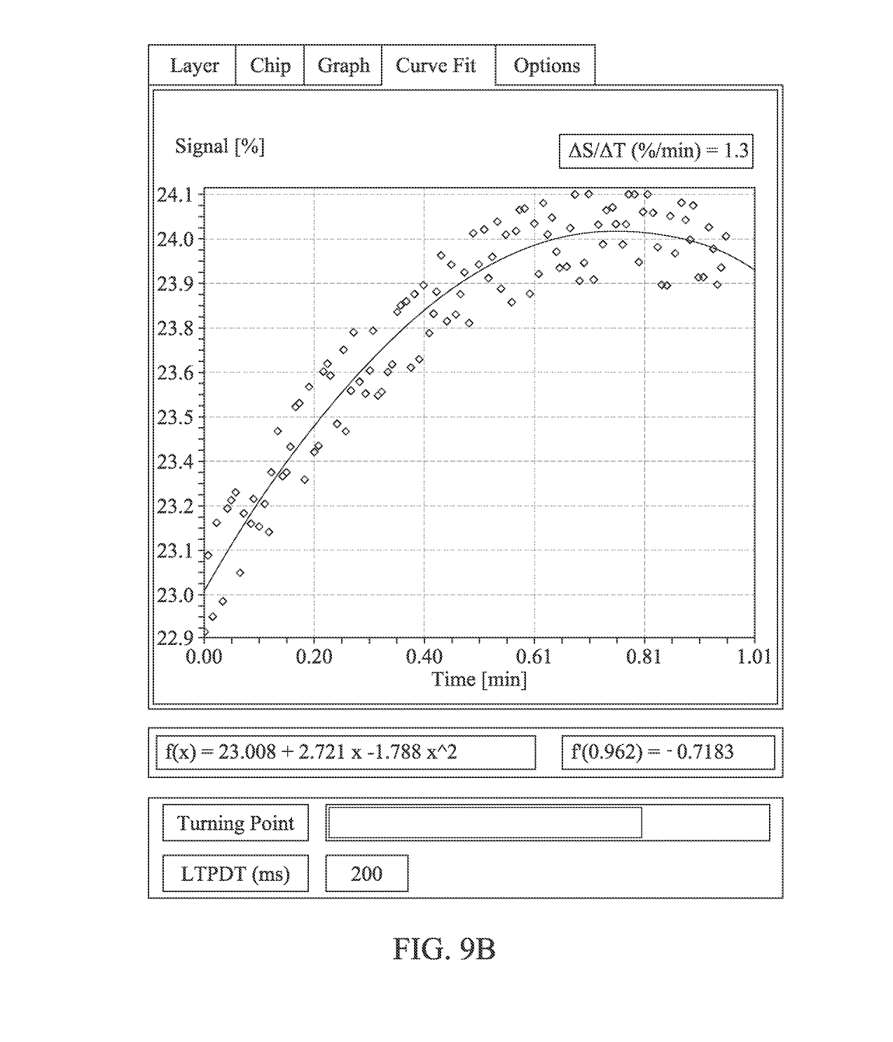

FIG. 9A is an example of the optical monitor signal from FIG. 8 recorded by the deposition monitor. By substituting values for QWTS=0.2, PT=82.2 nm, Rate=3 Å/s, OTQW=0.93, and OMSI=500 ms in the equation for PDP, the number of polynomial data points is 118. At the beginning of the layer growth, during the initial 59 s of the deposition, the sampled values of the optical monitor signal are collected until the number of data reaches 118. During that period, which is represented by the dotted line of the signal curve, the layer termination cannot be initiated through the curve fitting algorithm. When required number of data is reached, a polynomial regression algorithm is activated and the data size maintained at a constant level until the end of deposition. With each new data point, the oldest one is disposed of.

FIG. 9B shows the lifecycle of the regression function. The regression function is optimized each time a new sample is acquired. The acquisition frequency equals 2 Hz, which means that every 500 ms a new regression function is calculated. The same function and its first and second derivatives are evaluated at the frequency of 5 Hz, which is equivalent to the time interval of 200 ms. The most recent value of −0.7183 of the first derivative corresponds to x=0.962 min. The regression function is plotted for the period of 1.012 min, with the last 0.050 min representing the extrapolated values of the function. The number of polynomial data points is always kept at the reasonably high level. Therefore, even when the signal-to-noise ratio is low, the shape of the regression function is hardly affected and the turning point of the function can be precisely determined. In general, when the first derivative equals zero, and the second derivative is negative, the regression function has a maximum. Likewise, when the first derivative equals zero, and the second derivative is positive, the regression function has a minimum. From the FIG. 9B, the last turning point dwell time (LTPDT) is 200 ms, which indicates extremely high immunity of the regression function to the signal instability.

In the example from FIG. 8, and from the run sheet data shown in FIG. 9A, the layer should terminate when the optical monitor signal passes through one cycle, and the regression function reaches the relative value of 141.05% of the difference between the two previous extreme values of the monitoring signal. In this case those values are represented with a starting signal value of 16.87%, and the last maximum signal value of 24.06%. From these values, the layer deposition should terminate when the regression function reaches the value of 13.92%.

I claim:

1. A deposition controller for controlling deposition of an optical thin film coating on a substrate, comprising:
an input configured to be connected to an optical sensor, the optical sensor being configured to produce a signal describing electromagnetic radiation reflected or transmitted by an optical thin film coating;
a deposition rate and thickness monitor configured to be connected to a quartz crystal sensor, said deposition rate and thickness monitor being configured to receive a signal from the quartz crystal sensor, and to calculate a rate of deposition of each material being deposited on the substrate, and to calculate a physical thickness of the optical thin film coating being deposited; and
a digital computer connected to said input and said deposition rate and thickness monitor, said digital computer having an output configured to connect to a peripheral for terminating the deposition of the optical thin film coating, said digital computer transmitting a signal to the peripheral based on the signal describing electromagnetic radiation reflected or transmitted by the optical thin film coating and at least one of the rate of deposition of each material being deposited and the physical thickness of the optical thin film coating.

2. The controller according to claim 1, wherein said digital computer is a programmable logic controller.

3. The controller according to claim 1, further comprising a network interface controller said network interface controller being configured to transmit signals to and from said digital computer.

4. The controller according to claim 3, wherein said network interface controller is configured to connect to a TCP/IP network.

5. The controller according to claim 3, wherein said network interface controller is an Ethernet controller.

6. The controller according to claim 1, wherein said film deposition rate and thickness monitor is a quartz crystal sensor board.

7. The controller according to claim 4, further comprising a local computer, said local computer being configured to connect to a TCP/IP network, said local computer being configured to connect to said digital computer via said network interface controller.

8. A method for creating a run sheet file using a local computer, which comprises:
providing a thin film design file including a datum describing a thin film to be deposited;
providing a coating machine configuration file, said coating machine configuration file including a datum describing a coating machine in which the thin film is to be deposited;
providing a deposition controller configuration file, said deposition controller configuration file including a datum describing a deposition controller; and
writing an instruction for a deposition controller, said instruction being derived from said datum describing said deposition controller, said datum describing said coating machine, and said datum describing the thin films to be deposited.

9. The method according to claim 8, which further comprises:
providing a deposition controller for controlling deposition of an optical thin film coating on a substrate; and
writing said instruction to said deposition controller.

10. The method according to claim 9, which further comprises transmitting said instruction to said deposition controller via a TCP/IP network.

11. The controller according to claim 7, wherein:
said local computer is configured to send a datum describing an input/output configuration of said digital computer to said digital computer;
said local computer is configured to send a datum describing a source/sensor/optical monitor configuration of the coating machine to said digital computer; and
said local computer is further configured to send a run sheet file that considers deposition parameters of each layer to said digital computer;
said digital computer is configured to receive an input/output configuration of said digital computer sent by said local computer;
said digital computer is configured to receive a source/sensor/optical monitor configuration of the coating machine sent by said local computer; and
said digital computer is configured to receive a run sheet file that considers deposition parameters of each layer sent by said local computer.

12. The controller according to claim 11, wherein said digital computer is configured to terminate layer deposition based on a criterion contained in said run sheet.

13. The controller according to claim 1, wherein the signal received by said input is based on said optical sensor maintaining a given wavelength while monitoring growth of the optical thin film in a deposition chamber.

14. The controller according to claim 7, wherein:
said local computer is configured to calculate an optimized polynomial function fitting a set of signal values recorded by said optical sensor;
said local computer is configured to calculate first and second derivatives of said polynomial function;
said local computer is configured to calculate a number of turning points of said polynomial function and compare a value of said polynomial function to prescription data of said run sheet; and
said local computer initiates a termination event passed on to said digital computer when said polynomial function satisfies termination conditions defined by said run sheet.

15. A method for examining a run sheet file, which comprises:
defining a minimum layer optical thickness (MLOT) as a fractional value of a quarter wave optical thickness (QWOT) of a layer at a monitoring wavelength, where a MLOT coefficient has a value from 0.3 to 0.6;
suspending a deposition when a ratio of an optical thickness of the layer to the QWOT is less than the MLOT; and
suspending a deposition when a ratio of an optical thickness of the layer before the first turning point to the QWOT is less than the MLOT.

16. A method according to claim 15, which further comprises defining a quarter wave time segment (QWTS) as a fractional value of a quarter wave time when the optical film acquires an optical thickness equal to QWTS times QWOT.

17. A method according to the claim 16, wherein:
said QWTS is not less than 0.45 times MLOT; and
said QWTS is not more than 0.65 time MLOT.

18. A method for terminating deposition of a thin film layer, which comprises:
calculating a number of polynomial data points by dividing a product of a quarter wave time segment (QWTS) and a physical thickness (PT) of a layer by a product of a deposition rate (RATE) of the growing layer, an optical thickness of the layer (OTQW), and an optical monitor sampling interval (OMSI);
collecting said number of polynomial data points periodically by measuring an intensity of a light signal reflected from or transmitted through the growing thin film each time the OMSI passes;
calculating a polynomial regression function from said number of polynomial data points; and
terminating deposition of a thin optical layer when a first derivative of said polynomial regression function becomes zero, or when the value of the regression function reaches a certain predefined value.

19. The deposition controller according to claim 1, further comprising an output connected to said digital computer for transmitting a signal to at least one of a deposition source power controller, a deposition source position controller, a mass flow controller, a quartz crystal position controller, an optical chip change controller, an electron gun sweep controller, an ion gun power controller, a pneumatic actuator for the source shutter, a pneumatic actuator for the sensor shutter, a coating chamber gas inlet shut-off valve, and a user selectable remote device.

20. The deposition controller according to claim 1, further comprising an input connected to said digital computer for receiving a signal from at least one of a deposition source position controller, a quartz crystal position controller, a mass flow controller, a coating chamber pressure controller, and a user selectable remote device.

21. The deposition controller according to claim 1, wherein said deposition rate and thickness monitor is connected to a further quartz crystal sensor, said deposition thickness and rate monitor being configured to receive a signal from said further sensor.

22. The deposition controller according to claim 1, further comprising a relay connected to said digital computer.

23. The deposition controller according to claim 1, wherein said input is analog.

24. The deposition controller according to claim 1, wherein said output is digital.

25. The deposition controller according to claim 19, wherein said output is analog.

26. The deposition controller according to claim 19, wherein said output is digital.

27. The deposition controller according to claim 20, wherein said input is analog.

28. The deposition controller according to claim 20, wherein said input is digital.
